(19) United States
(12) Patent Application Publication
(10) Pub. No.: US 2021/0120996 A1
(43) Pub. Date: Apr. 29, 2021

(54) Systems And Methods For Providing Steam To A Cooking Chamber Using A Piezo-Electric Atomizer And A Water Heater

(71) Applicant: Viking Range, LLC, Greenwood, MS (US)

(72) Inventor: Jemsheer Thayyullathil, Greenwood, MS (US)

(73) Assignee: Viking Range, LLC, Greenwood, MS (US)

(21) Appl. No.: 17/077,101

(22) Filed: Oct. 22, 2020

Related U.S. Application Data
(60) Provisional application No. 62/926,051, filed on Oct. 25, 2019.

(51) Int. Cl. A47J 27/04; A47J 27/00; A47J 36/32; A23L 5/10; B05B 17/06

(52) U.S. Cl. CPC A47J 27/04; A47J 27/004; A47J 36/32; A23V 2002/00; B05B 17/0607; A47J 2027/043; A47J 2202/00; A23L 5/13

(57) ABSTRACT

A device for cooking food may include a steam-generating chamber, which may provide steam to a cooking chamber at a regulated steam temperature, that may comprise a liquid-heating element and an atomizer. The liquid-heating element may heat a liquid to a regulated liquid temperature, which may be less than a boiling temperature of the liquid. The regulated steam temperature may be based on the regulated liquid temperature. The cooking chamber may include an air-heating element, which may heat the air within the cooking chamber. The air-heating element may be heated to a regulated heater temperature less than the boiling temperature of the liquid. The cooking chamber may receive the steam, and maintain the air within the cooking chamber at a regulated air temperature based on the regulated heater temperature of the air-heating element and the regulated steam temperature of the steam.

This application claims under 35 U.S.C. § 119(e)(1) the benefit of U.S. Provisional Application No. 62/926,051, filed Oct. 25, 2019, the entire contents of which are incorporated herein by reference.

This patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present disclosure relates in general to the field of ovens for cooking food, and in particular to systems and methods for providing steam at a certain temperature to a cooking chamber using a piezo-electric ultrasonic atomizer and a water heater.

### BRIEF DESCRIPTION OF THE DRAWINGS

The foregoing and other objects, features, and advantages for embodiments of the present disclosure will be apparent from the following more particular description of the embodiments as illustrated in the accompanying drawings, in which reference characters refer to the same parts throughout the various views. The drawings are not necessarily to scale, emphasis instead being placed upon illustrating principles of the present disclosure.

FIG. 1 is a drawing illustrating a side view of an embodiment including a device for providing steam to a cooking chamber from an adjacent chamber having an atomizer and a water heater, in accordance with certain embodiments of the present disclosure.

FIG. 2 is a drawing illustrating a side view of an embodiment including a device for providing steam to a cooking chamber from an adjacent chamber having an atomizer that may receive hot water, in accordance with certain embodiments of the present disclosure.

FIG. 3 is a flowchart illustrating an embodiment including a method for providing steam to a cooking chamber from an adjacent chamber having an atomizer and a water heater, in accordance with certain embodiments of the present disclosure.

### DETAILED DESCRIPTION OF EMBODIMENTS OF THE INVENTION

Reference will now be made in detail to the embodiments of the present disclosure, examples of which are illustrated in the accompanying drawings.

Embodiments of the present disclosure may enable a more efficient method for cooking food within a cooking chamber with steam produced in an adjacent chamber using an atomizer and a water heater. A benefit of the present disclosure may include an overall reduction in the thermal energy required for cooking food within a steam oven. An advantage of the disclosure may include the lower amount of energy required to heat and atomize a liquid within a small chamber, versus the greater amount of energy required to heat a large cooking chamber in order to generate steam within the cooking chamber. In accordance with certain embodiments of the disclosure, the steam may be emitted into a cook chamber at a certain cooking temperature. In some embodiments, the cooking chamber would not need to be heated above the boiling temperature of the liquid. Rather, the heated steam may be maintained at a cooking temperature using a heating element within the cooking chamber at a temperature less than the boiling temperature of the liquid. Such a method may enable sous-vide cooking with less energy and more control. In certain embodiments, a controller may be used to monitor and adjust temperatures in order to provide a more effective cooking system.

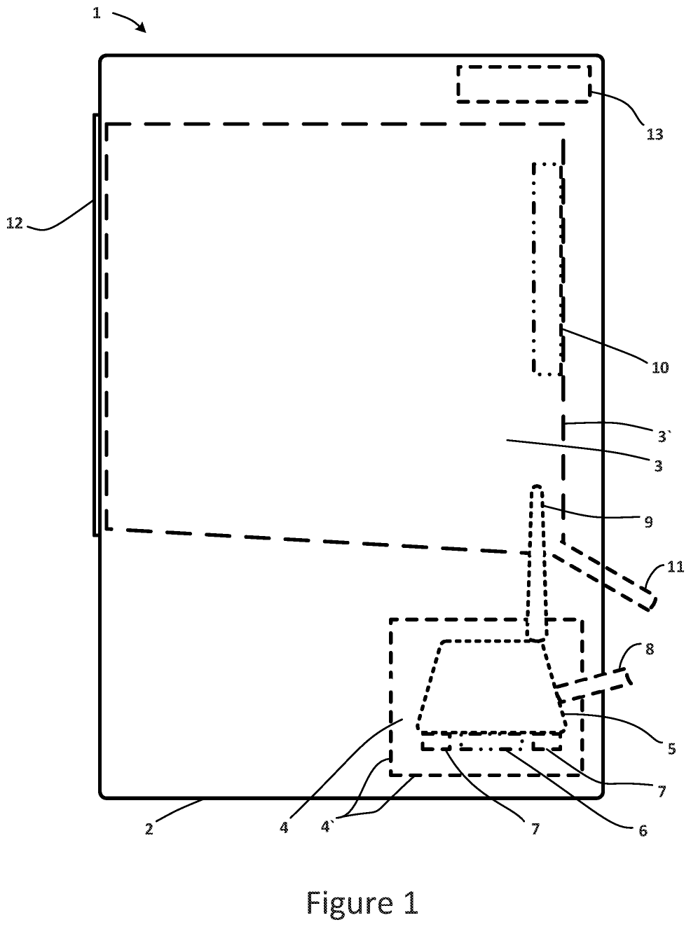

Referring to FIG. 1, an embodiment of the present disclosure may include a system 1 having a housing 2 that encloses a cooking chamber 3 and a steam-generating chamber 4. The steam-generating chamber 4 may be located within the housing 2. The steam-generating chamber 4 may be defined by steam-generating chamber walls 4′ mounted within the housing 2. The steam-generating chamber 4 may be configured to emit steam (not shown) into the cooking chamber 3. In some embodiments, the emitted steam may have a regulated steam temperature.

In certain embodiments, the steam-generating chamber 4 may include a liquid reservoir 5 for storing liquid (not shown) such as water. The liquid reservoir 5 may be mounted within the steam-generating chamber 4 adjacent to a liquid-heating element 6 and an atomizer 7. In embodiment, the housing 2 may include a liquid-supply opening. The liquid reservoir 5 may be adapted to receive liquid through the liquid-supply opening. In some embodiments, a water-supply hose 8 may receive water from piping and deliver the water to the liquid-reservoir 5 through such as liquid-supply opening.

In certain embodiments, the liquid-heating element 6 may be an electric heating element 6 adapted to heat liquids. The steam-generating chamber 4 may include a liquid-heating element 6 configured to heat a liquid to a regulated liquid temperature, which may be less than the boiling temperature of the liquid at atmospheric pressure. The steam-generating chamber 4 may include an atomizer 7 configured to generate atomized particles (not shown) of the liquid. The atomizer 7 may be a piezo-electric ultrasonic atomizer 7. In some embodiments, a plurality of atomizers 7 may be utilized. The atomized particles may be generated by a phase change from a liquid state to a gaseous state. The atomized particles may comprise the steam emitted from the steam-generating chamber 4 and received by the cooking chamber 3. The steam may travel from the former chamber 4 to the latter chamber 3 via a conduit 9, which operably connects the two chambers. The conduit 9 may comprise a steam duct 9 positioned between the steam-generating chamber 4 and the cooking chamber 3, which may be configured to transfer the steam in one direction from the steam-generating chamber 4 to the cooking chamber 3.

The cooking chamber 3 may be defined by cooking chamber walls 3′ mounted within the housing 2. The cooking chamber 3 may be located adjacent to the steam-generating chamber 4. The cooking chamber 3 may be adapted to receive the steam emitted from the steam-generating chamber 4. The cooking chamber 3 may have an air-heating element 10 configured to be heated to a regulated heater temperature, which may be less than the boiling temperature of the liquid at atmospheric pressure. The cooking chamber 3 may be configured to maintain a regulated air temperature of the air (not shown) within the cooking chamber 3 based on the regulated heater temperature of the air-heating element 10 and the regulated steam temperature of the steam received within the cooking chamber 3.

In an embodiment, the bottom wall 3′ of the cooking chamber 3 may be sloped so that any condensation produced by the steam within the cooking chamber 3 may be directed towards a condensation receptor 11. The condensation receptor 11 may be adapted to receive condensation from the cooking chamber 3. The condensation receptor 11 may be mounted within the housing 2 adjacent to the cooking chamber 3. The housing 2 may include a condensation-removal opening. The condensation receptor 11 may be adapted to provide condensation through the condensation-removal opening. The cooking chamber 3 may be configured to receive a food product (not shown). The food product may be received via an opening in the housing 2. A door 12 may cover this opening.

In some embodiments, the regulated steam temperature of the steam may be regulated based on the regulated liquid temperature of the liquid. In certain embodiments, the liquid may comprise water. The boiling temperature of the liquid may be within the temperature range of 210° Fahrenheit (98.8° Celsius) and 214° Fahrenheit (101.1° Celsius) at atmospheric pressure. The regulated liquid temperature may be less than 212° Fahrenheit (100° Celsius). The regulated steam temperature of the emitted steam may be less than 212° Fahrenheit (100° Celsius). The regulated heater temperature may be less than 212° Fahrenheit (100° Celsius). The regulated air temperature may be less than 212° Fahrenheit (100° Celsius). In an embodiment, the food product may comprise meat and the regulated air temperature may be between 131° Fahrenheit (55° Celsius) and 140° Fahrenheit (60° Celsius).

In an embodiment, the system 1 may include a controller 13 mounted within the housing 2. The controller 13 may be adapted to receive a temperature reading (not shown). The temperature reading may be transmitted by a sensor (not shown), which may be adapted to determine a monitored temperature. The monitored temperature may include the regulated liquid temperature, the regulated steam temperature of the emitted steam, the regulated heater temperature, and/or the regulated air temperature. The controller 13 may be further adapted to adjust a system temperature. The system temperature may include the regulated liquid temperature, the regulated steam temperature of the emitted steam, the regulated heater temperature, and/or the regulated air temperature.

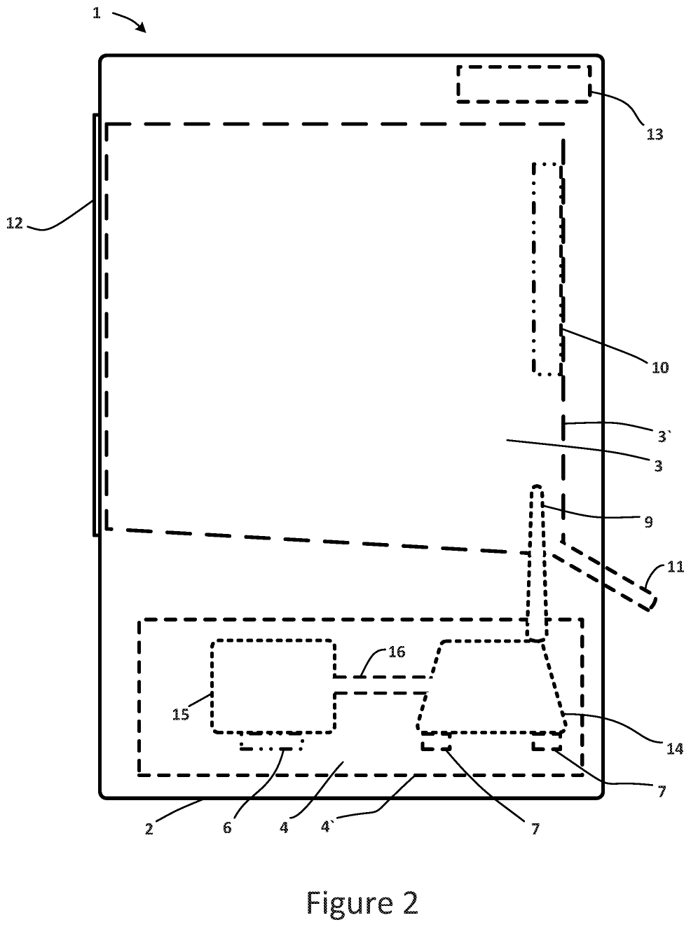

FIG. 2 illustrates an embodiment of the disclosed system 1 including a steam-generating chamber 4 that comprises an atomizing chamber 14 that is separate from a heating chamber 15. In an embodiment, the heating chamber 15 may store liquid (not shown) such as water. Cold or lukewarm liquid may be received by the heating chamber 15 via a water-supply hose 8 (not shown), which may enter the housing 2 through a liquid-supply opening. The heating chamber 15 may be mounted within the steam-generating chamber 4 adjacent to a liquid-heating element 6. The heating chamber 15 may be fluidly connected to the atomizing chamber 14 via a fluid conduit 16. In an embodiment, the fluid conduit 16 may receive heated water from the heating chamber 15 and deliver the heated water to the atomizing chamber 14. The atomizing chamber 14 may be mounted within the steam-generating chamber 4 adjacent to an atomizer 7. As disclosed above, the liquid-heating element 6 may be configured to heat a liquid to a regulated liquid temperature, which may be less than the boiling temperature of the liquid at atmospheric pressure, and the atomizer 7 may be configured to generate atomized particles (not shown) of the liquid. The atomized particles may comprise the steam emitted from the steam-generating chamber 4 and received by the cooking chamber 3 a conduit 9. In certain embodiments, the atomizer 7 may be placed inside the heating chamber 15. Accordingly, in some embodiments, the heating chamber 15 and the atomizing chamber 14 may be the same chamber.

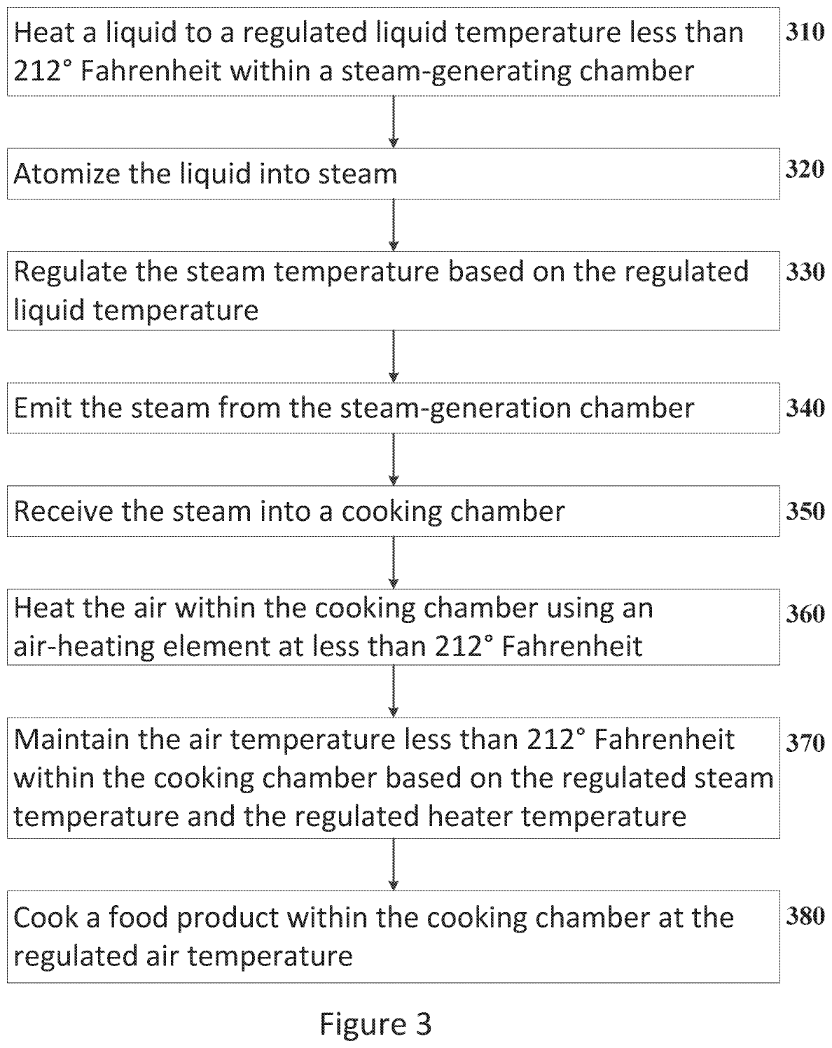

Referring to FIG. 3, an embodiment of the disclosure may include a method for providing steam to cook the food product within the cooking chamber 3 of the system 1 illustrated in FIG. 1 or FIG. 2. The method may include the steps of heating [block 310] a liquid via the liquid-heating element 6 within the steam-generating chamber 4, and atomizing [block 320] the liquid to generate steam. The liquid may be heated to a regulated liquid temperature, which may be less than 212° Fahrenheit (100° Celsius). In some embodiments, the method may include the step of regulating [block 330] the regulated steam temperature of the steam within the steam-generating chamber 4 based on the regulated liquid temperature of the liquid.

The method may include the steps of emitting [block 340] the steam from the steam-generating chamber 4, and receiving [block 350] the emitted steam into the cooking chamber 3. In certain embodiments, the method may further include the steps of heating [block 360] the air within the cooking chamber 3 via an air-heating element 10, and maintaining [block 370] the regulated air temperature of the air within the cooking chamber 3 based on the regulated heater temperature of the air-heating element 10 and the regulated steam temperature of the steam received within the cooking chamber 3. As discussed above, the regulated heater temperature may be less than 212° Fahrenheit (100° Celsius), and the regulated air temperature may be less than 212° Fahrenheit (100° Celsius). In addition, the method may include the step of cooking [block 380] a food product within the cooking chamber 3 at the regulated air temperature.

An embodiment may include a device 1 for providing steam to cook the food product within the cooking chamber 3. The device 1 may comprise a home appliance 1 adapted to be mounted within a kitchen. The home appliance may include casing or walls 2, which may comprise the housing 2 for the steam-generating chamber 4 and the cooking chamber 3. The housing 2 may define a door opening adapted to receive a door 12 to enable an user to access the cooking chamber 3. In an embodiment, the liquid reservoir 5 and the condensation receptor 11 may be located within the home appliance 1. The condensation receptor 11 may be adapted to remove condensation from the cooling chamber 3 through the condensation-removal opening. The condensation receptor 11 may be adapted to connect to a drain, which may carry away the condensation.

While the present disclosure has been particularly shown and described with reference to an embodiment thereof, it will be understood by those skilled in the art that various changes in form and details may be made therein without departing from the spirit and scope of the present disclosure. Although some of the drawings illustrate a number of operations in a particular order, operations that are not order-dependent may be reordered and other operations may be combined or broken out. While some reordering or other groupings are specifically mentioned, others will be apparent to those of ordinary skill in the art and so do not present an exhaustive list of alternatives.

What is claimed is:

1. A system for providing steam to a cooking chamber, comprising:
steam-generating chamber walls mounted within a housing, the steam-generating chamber walls defining a steam-generating chamber located within the housing, the steam-generating chamber configured to emit the steam into the cooking chamber, the emitted steam having a regulated steam temperature, the steam-generating chamber comprising:
a liquid-heating element configured to heat a liquid to a regulated liquid temperature less than a boiling temperature of the liquid; and,
an atomizer configured to generate atomized particles of the liquid, the atomized particles generated by a phase change from a liquid state to a gaseous state, the atomized particles comprising the steam, wherein the regulated steam temperature of the steam is regulated based on the regulated liquid temperature of the liquid; and,
cooking chamber walls mounted within the housing, the cooking chamber walls defining the cooking chamber, the cooking chamber configured to receive a food product, the cooking chamber located adjacent to the steam-generating chamber, the cooking chamber adapted to receive the steam emitted from the steam-generating chamber, the cooking chamber having an air-heating element configured to be heated to a regulated heater temperature less than the boiling temperature of the liquid, the cooking chamber configured to maintain a regulated air temperature of air within the cooking chamber based on the regulated heater temperature of the air-heating element and the regulated steam temperature of the steam received within the cooking chamber.

2. The system of claim 1, further comprising:
a steam duct positioned between the steam-generating chamber and the cooking chamber, the steam duct configured to transfer the steam from the steam-generating chamber to the cooking chamber.

3. The system of claim 1, wherein the liquid comprises water, and wherein the boiling temperature of the liquid is within the temperature range of 210° Fahrenheit (98.8° Celsius) and 214° Fahrenheit (101.1° Celsius) at atmospheric pressure.

4. The system of claim 1, wherein the regulated liquid temperature is less than 212° Fahrenheit (100° Celsius).

5. The system of claim 1, wherein the regulated steam temperature of the emitted steam is less than 212° Fahrenheit (100° Celsius).

6. The system of claim 1, wherein the regulated heater temperature is less than 212° Fahrenheit (100° Celsius).

7. The system of claim 1, wherein the regulated air temperature is less than 212° Fahrenheit (100° Celsius).

8. The system of claim 1, wherein the regulated air temperature is between 131° Fahrenheit (55° Celsius) and 140° Fahrenheit (60° Celsius), and the food product comprises meat.

9. The system of claim 1, wherein the liquid-heating element is an electric heating element adapted to heat the liquid.

10. The system of claim 1, wherein the atomizer is a piezo-electric ultrasonic atomizer.

11. The system of claim 1, further comprising:
a controller mounted within the housing, the controller adapted to receive a temperature reading, the controller adapted to adjust a system temperature.

12. The system of claim 11, wherein the temperature reading is transmitted by a sensor adapted to determine a monitored temperature selected from a group consisting of: the regulated liquid temperature, the regulated steam temperature of the emitted steam, the regulated heater temperature, and the regulated air temperature.

13. The system of claim 11, wherein the system temperature is selected from a group consisting of: the regulated liquid temperature, the regulated steam temperature of the emitted steam, the regulated heater temperature, and the regulated air temperature.

14. A method for providing steam to cook the food product within the cooking chamber of the system of claim 1, comprising the steps of:
heating the liquid via the liquid-heating element within the steam-generating chamber;
atomizing the liquid to generate the steam;
regulating the regulated steam temperature of the steam within the steam-generating chamber based on the regulated liquid temperature of the liquid;
emitting the steam from the steam-generating chamber;
receiving the emitted steam into the cooking chamber;
heating the air within the cooking chamber via the air-heating element;
maintaining the regulated air temperature of air within the cooking chamber based on the regulated heater temperature of the air-heating element and the regulated steam temperature of the steam received within the cooking chamber; and,
cooking the food product within the cooking chamber at the regulated air temperature.

15. A device for providing steam to cook the food product within the cooking chamber of the system of claim 1, comprising:
a home appliance adapted to be mounted within a kitchen, the home appliance comprising walls defining the housing for the steam-generating chamber and the cooking chamber, the housing defining a door opening adapted to receive a door for access to the cooking chamber; and,
a liquid reservoir adapted to store the liquid, the liquid reservoir mounted within the steam-generating chamber adjacent to the liquid-heating element and the atomizer, the housing defining a liquid-supply opening, the liquid reservoir adapted to receive the liquid through the liquid-supply opening.

16. The device of claim 15, further comprising:
a condensation receptor adapted to receive condensation from the cooking chamber, the condensation receptor mounted adjacent to the cooking chamber, the housing defining a condensation-removal opening, the condensation receptor adapted to provide the condensation through the condensation-removal opening, the condensation receptor adapted to connect to a drain.
